(19) United States
(12) Patent Application Publication
(10) Pub. No.: US 2016/0235041 A1
(43) Pub. Date: Aug. 18, 2016

(54) METHOD AND APPARATUS FOR UNLOADING LIVE POULTRY

(71) Applicant: Mountaire Farms of Delaware, Inc., Wilmington, DE (US)

(72) Inventor: Jeffrey H. Walther, Salisbury, MD (US)

(21) Appl. No.: 15/047,401

(22) Filed: Feb. 18, 2016

Related U.S. Application Data
(60) Provisional application No. 62/117,675, filed on Feb. 18, 2015.

(51) Int. Cl. A01K 45/00

(52) U.S. Cl. CPC A01K 45/005

(57) ABSTRACT

A method for unloading live poultry onto a horizontal receiving surface from a multi-level transportation container having an access side with an opening at each level and a door for closing each opening. The method includes receiving the transportation container within a support cradle that is rotatably supported on one or more pivot mounts, with the access side of the transportation container in a substantially vertical orientation. The method further includes rotating the support cradle and the transportation container together through an angle of about 90 degrees until the access side of the transportation container is in a substantially horizontal orientation above the horizontal receiving surface while maintaining the doors is a closed position, and upon reaching the substantially horizontal orientation, activating a door opening mechanism to open the doors for each level of the transportation container to deposit the live poultry contained therein onto the horizontal receiving surface.

### CROSS-REFERENCE TO RELATED APPLICATIONS

This application claims the benefit of U.S. Provisional Patent Application No. 62/117,675, filed 18 Feb. 2015, and entitled “Method and Apparatus for Unloading Live Poultry,” which application is incorporated by reference in its entirety herein, and for all purposes.

### FIELD OF THE INVENTION

The present invention generally relates to a method and apparatus for transferring live birds at a poultry processing facility, and specifically to a method and apparatus for gently unloading live birds from transportation containers onto an intake conveyor system.

### BACKGROUND

Historically, the unloading of live poultry from transport cages and coops has been characterized by either handling or dumping from an elevated coop or cage into a containment area. Traditional manual handling (i.e. the manual grasping of legs and pulling of birds from containers) is a labor-intensive process that can impose stresses on leg joints and musculature of the poultry during transfer from the transportation container to the receiving conveyor, resulting in bloody thighs and discolored hocks. On the other hand, while dumping the birds from their elevated containers can reduce manpower requirements, the rapid displacement and sensation of being in free fall caused by current equipment configurations can elicit a “fight or flight” response in the birds that is often characterized by violent wing flapping, which in turn can lead to joint dislocation, bone breakage and contusions. Breast bruising and punctured livers also have been traced to the dumping of live birds from elevated cages.

Consequently, a need exists for a method and apparatus for unloading live poultry from transportation containers that deliver the poultry to the intake conveyor in a less-forceful and less-stressful manner that avoids damage to the poultry, and that is also not labor intensive. It is toward such a method and apparatus that the present disclosure is directed.

### SUMMARY

In accordance with one embodiment, the present disclosure includes a method for unloading live poultry onto a horizontal receiving surface from a multi-level transportation container or cage, with the transportation container having an access side with an opening at each level and a door for closing each opening. The method generally includes receiving the transportation container within a support cradle that is rotatably supported on one or more pivot mounts, with the access side of the transportation container in a substantially vertical orientation. The method further includes rotating the support cradle and the transportation container together through an angle of about 90 degrees until the access side of the transportation container is in a substantially horizontal orientation above the horizontal receiving surface, and activating a door opening mechanism to open the doors for each level with the transportation container to gently deposit, in a substantially vertical fashion, the live poultry contained therein onto the horizontal receiving surface.

Another embodiment of the disclosure includes an apparatus for unloading live poultry from a multi-level transportation container onto a horizontal receiving surface, in which the transportation container has an access side with an opening at each level and a door for closing each opening. The apparatus generally comprises a cradle that includes a base platform that is configured to receive and support the bottom of the transportation container, a side support extending upward from a side of the base platform and configured to receive and support the access side of the transportation container, and one or more support pillars extending downward to engage with at least one pivot mount that is spaced from and below the base platform. The apparatus also includes a power mechanism that is configured to rotate the cradle, with a transportation container received therein, from an upright position with the access side in a substantially vertical orientation, around the pivot mount to an unload position, with the access side in a substantially horizontal orientation spaced from and above the horizontal receiving surface. The apparatus further includes a door-opening mechanism that is configured to open the doors for each level with the transportation container in the unload position to gently deposit live poultry contained therein onto the horizontal receiving surface.

The invention will be better understood upon review of the detailed description set forth below taken in conjunction with the accompanying drawing figures, which are briefly described as follows.

### BRIEF DESCRIPTION OF THE DRAWINGS

FIG. 1 is an exploded perspective view of an apparatus for unloading live poultry from transportation containers, in accordance with a representative embodiment of the present disclosure.

FIG. 2 is a perspective view of a multi-level transportation container for use with the unloading apparatus of FIG. 1.

FIG. 3 is a schematic side view of the unloading apparatus of FIG. 1 with the transportation container in an upright position.

FIG. 4 is a schematic side view of the unloading apparatus of FIG. 1 with the transportation container in an unload position.

FIG. 5 is another schematic side view of the unloading apparatus with the transportation container in an unload position, in accordance with another representative embodiment.

FIG. 6 is a schematic view of a door-opening mechanism for opening the doors to each level of the multi-level transportation container, in accordance with yet another representative embodiment.

FIG. 7 is a side view of the unloading apparatus with the transportation container in an upright position, in accordance with yet another representative embodiment.

FIG. 8 is a side view of the unloading apparatus of FIG. 7 with the transportation container in an unload position.

FIG. 9 is front view of the rotatable cradle of the uploading apparatus of FIG. 7.

FIG. 10 is side view of the rotatable cradle of the uploading apparatus of FIG. 7.

Those skilled in the art will appreciate and understand that, according to common practice, various features and elements of the drawings described above are not necessarily drawn to scale, and that the dimensions and relative positions between the features or elements may be expanded, reduced or otherwise altered to more clearly illustrate the various embodiments of the present disclosure depicted therein.

### DETAILED DESCRIPTION

The following description, in conjunction with the accompanying drawings described above, is provided as an enabling teaching of exemplary embodiments of a method and apparatus for gently transferring or unloading live birds at a poultry processing facility. As described below, the method and apparatus can provide several significant advantages and benefits over other methods or systems for unloading birds from transportation containers to an intake conveyor system. However, the recited advantages are not meant to be limiting in any way, as one skilled in the art will appreciate that other advantages may also be realized upon practicing the present disclosure.

Furthermore, those skilled in the relevant art will recognize that changes can be made to the described embodiments while still obtaining the beneficial results, and that some of the advantages and benefits of the described embodiments can be obtained by selecting some of the features of the embodiments without utilizing other features, and that features from one embodiment may be combined with features from other embodiments in any appropriate combination. For example, any individual or collective features of method embodiments may be applied to apparatus, product or system embodiments, and vice versa. Accordingly, those who work in the art will recognize that many modifications and adaptations to the embodiments described are possible and may even be desirable in certain circumstances, and are a part of the disclosure. As such, the present disclosure is provided as an illustration of the principles of the embodiments and not in limitation thereof, since the scope of the invention is to be defined by the claims.

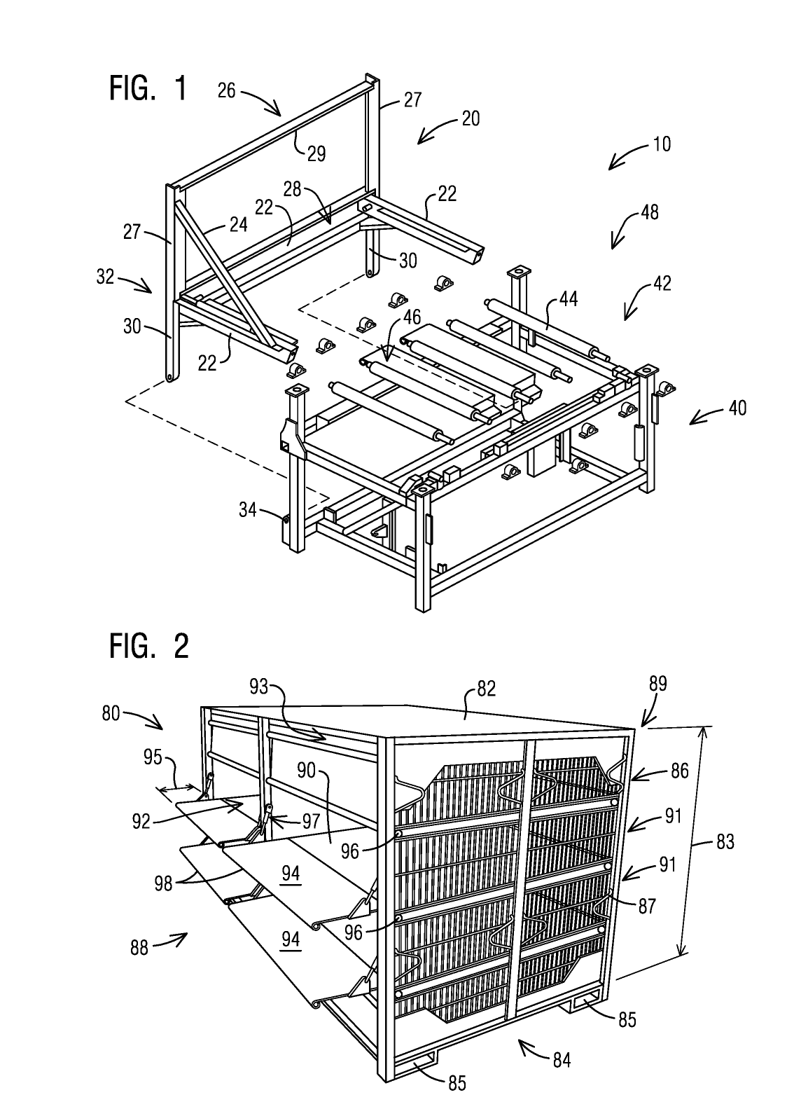

Referring now in more detail to the drawing figures, wherein like parts are identified with like reference numerals throughout the several views, FIG. 1 illustrates one embodiment of an apparatus 10 for unloading live poultry from a transportation container onto a horizontal receiving surface. The unloading apparatus 10 generally includes a rotatable cradle 20 with a base platform 22 that defines the portion of a receiving framework 28 that is configured to receive and support the bottom 84 of the transportation container 80 (FIG. 2). As shown in FIG. 1, in one aspect the base platform 22 of the cradle 20 can comprise a U-shaped frame that may include a rabbet or recess that securely captures the bottom edges at both ends 86, and optionally along the access side 88, of the container 80. The cradle 20 also has a side support 26 that extends upwardly from one side of the base platform 22 to define the portion of the receiving framework 28 that is configured to receive and support the access side 88 of the transportation container 80 during rotation. The side support 26 can comprise side bars 27 and one or more crossbars 29. In addition, the cradle 20 can also include one or more end braces 24 extending between the base support 22 and the side support 26 that provide the cradle 20 with additional strength and rigidity for securing the loaded transportation container 80, which can weight as much as 1,500 lbs., as it is rotated through an arc from an initial upright position to a substantially horizontal position for unloading. In one aspect the end brace 24 can also serve as a stop to correctly position the transportation container on top the arms of the U-shaped base platform 22.

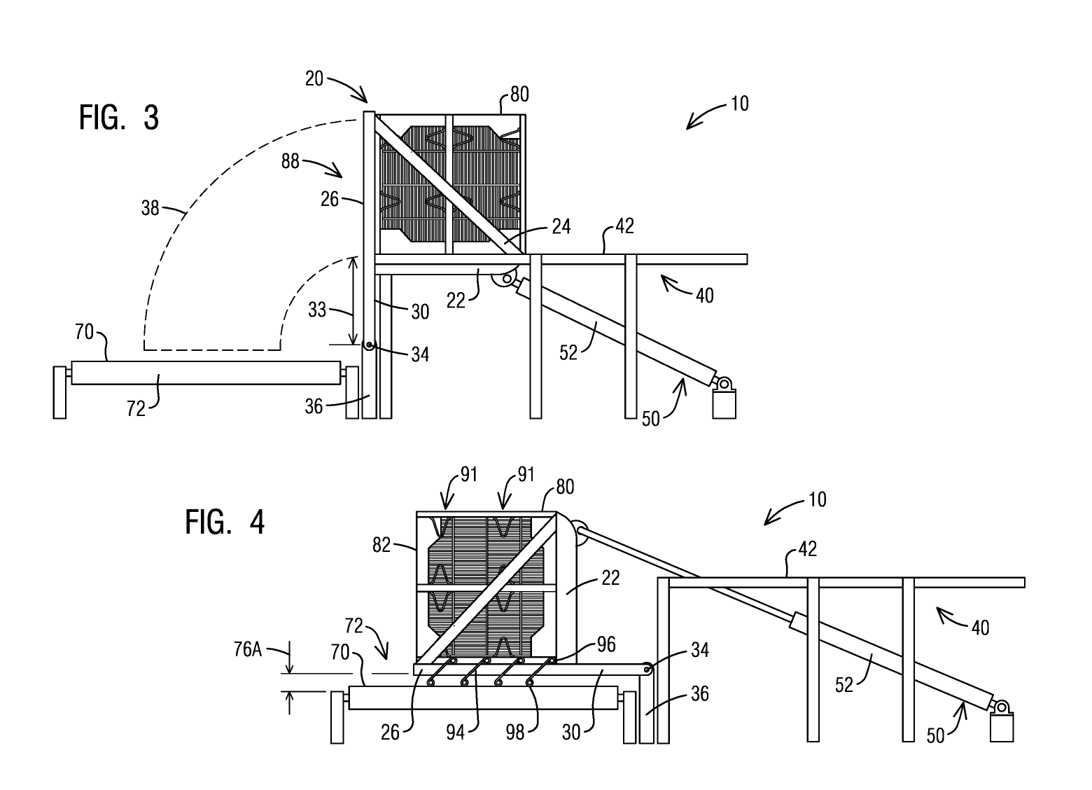

The rotatable cradle 20 further includes one or more support pillars 30 that extend downward below the base platform 22 to engage with one or more pivot mounts 34 (FIG. 3) that are spaced below the base platform 22, with the support pillars 30 acting to elevate the base platform 22 of the cradle 20 above an axis of rotation defined by the pivot mounts 34. As shown in FIG. 1, the rotatable cradle 20 generally includes a support pillar 30 extending downward from both ends of the base platform 22, with each being rotatably supported on its own pivot mount 34. Moreover, in one aspect the support pillars 30 and side bars 27 of the side support 26 can be formed together or combined together into elongate columns of high-strength structural material, such as carbon steel, steel alloy and the like.

Also shown in FIG. 1 is a stationary frame 40 that provides the unloading apparatus 10 with an upper platform 42 for receiving the transportation containers 80 in an elevated position prior to loading into the cradle 20, and for receiving and carrying away the containers 80 after the unloading of the live poultry contained therein. In one aspect the upper platform 42 can be defined by a plurality of rollers 42 that allow the transportation containers to be rolled onto and away from the frame 40 from an end 48 of the platform 42 opposite the side brace(s) 24 of the cradle, as well as one or more lateral loaders 46 that can move the containers into and out of engagement with the receiving framework 28 of the cradle 20 or onto another series of rollers (not shown) that can carry the empty container to a washing station or to a loading dock for transport back to a poultry farm for re-loading with poultry.

An exemplary embodiment of a multi-level transportation container 80 that can be used with the unloading apparatus of FIG. 1 is shown in FIG. 2. Generally, the transportation container includes a top panel 82, a bottom panel 84, end wall panels 86, an access side 88, and a back side panel 89 opposite the access side. In one aspect the top panel 82 and the bottom panel 84 can be substantially solid across the expanse thereof to provide protection for the birds during transportation, while the end panels 86 and the back side panel 89 opposite the access side 88 can be formed from a grating that facilitate the ventilation of the enclosure. In addition, lifting slots 85 configured to receive the forks of a forklift can also be integrated into the bottom panel 84 to facilitate the movement and storage of the transportation container 80. In one aspect the transportation container 80 can have a height 83 of about 4 feet (48 inches) between the top panel 82 and the bottom panel 84, a depth between the access side 88 and the back side panel 89 of about the same distance, a width between end wall panels 86 of about 8 feet, and one or more center panels that divide the transportation container 80 into two or more sections.

Also shown in FIG. 2, the transportation container 80 can include a plurality of interior floor panels 90 that divide the container vertically into multiple levels 91, in this case four levels, with each level 91 having sufficient clearance to allow the birds to remain upright and standing during transportation. In addition, each level 91 can include one or more access openings 92 on the access side 88 of the container 88, with doors 94 that generally swing outward and downward from their closed, upright positions so that, in one aspect, the inside surfaces of the doors 94 can be substantially flush or aligned with the top surfaces of their respective floor panels 90 when the doors 90 are in their fully open position. This feature can ease the passage of the birds into and out of the container 80.

The doors 94 can generally pivot around lower door pivots 96 that are aligned with the floor panels 90, with the outer edges 98 of the doors extending away from the container 80 a distance or height 95 of the door 94 that, in one aspect, can be customized to be less than the spacing between floor panels 90. Thus, when the doors 94 are in their upright and fully closed position, the reduced door height can create gaps 93 between the upper edges 98 of the doors 94 and the next upper level 91 that eliminate pinch points that could otherwise damage wings or cause head trauma to the live poultry during their initial loading into the transportation container 80. The gaps 93 can also provide for additional ventilation when the doors 94 are closed.

The doors 94 can also be spring-loaded toward both the closed position and the open position by compression springs 97 which encounter a neutral or centered position when the door is rotated open or outward between about twenty degrees and about forty degrees, as referenced from the upright plane of the access side 88 of the container 80. If the angular position of the door is less than the neutral position, the compression springs 97 can operate to push the door 94 shut. Alternatively, if the angular position of the door is greater than the neutral position, the compression springs 97 can operate to push the door 94 open.

Although the multi-level transportation container 80 of FIG. 2 is shown with, among other things, four levels 91, a specific vertical grating 87 construction, and a specific access door 94 construction, it is to be appreciated that the present disclosure is not limited to the particular transportation container 80 illustrated in the drawing. For example, the transportation container could be divided into five levels in order to carry smaller poultry animals. Likewise, it is further contemplated that other types or models of transportation containers of varying design could also be used with one or more embodiments of the unloading apparatus described herein, with each falling within the scope of the present disclosure.

FIG. 3 is a schematic side view of the unloading apparatus 10 of FIG. 1 with a transportation container 80 filled with live poultry secured within the cradle 20 in an upright position, with the access side 88 in a substantially vertical orientation. The unloading apparatus 10 is generally located adjacent to a horizontal receiving surface 70 that is adapted to receive the live poultry after unloading. In the illustrated embodiment, the horizontal receiving surface 70 can comprise the translatable belt of an intake conveyor 72 that carries the poultry into a processing facility. In one aspect the intake conveyor 72 can operate in an intermittent fashion, in which the belt is stopped during the unloading process so that the poultry is deposited on a stationary segment of the belt. The belt can then be cycled forward to carry the poultry into the facility while simultaneously exposing a new segment for the unloading of the next container 80. In other aspects, however, it may be preferable for the intake conveyor 72 to operate without stopping to present a continuously-moving horizontal receiving surface 70 to the unloading apparatus 10. It will be appreciated that the unloading apparatus 10 can be modified as needed to accommodate both intake conveyor configurations without risk of damage or stress to the live poultry during the unloading process.

As described above, the transportation container 80 may be rolled across the upper platform 42 of the stationary frame 40 prior to being received within the receiving framework 28 defined by the base platform 22 and the side support 26 (FIG. 1). Once the access side 88 of the container 80 is received within side support 26 of the cradle 20, a power mechanism 50, such as the double-acting hydraulic cylinder 52, can be activated to rotate the cradle 20 and loaded container 80 together about the pivot mount 34 that is spaced some distance 33 below the base platform 22. As shown in FIG. 3, this distance 33, or radius of rotation of the base of the transportation container, can be the difference between the height of the engagement surface of the side support of the base platform 22 above the horizontal receiving surface 70 and the height of the pivot mount 34 above the receiving surface 70. As discussed in more detail below, the distance 33 may be selected to center the transportation container 80 above the horizontal receiving surface 70 of the intake conveyor 72. Although shown as a hydraulically-actuated cylinder 52, it is to be appreciated that the power mechanism 50 can comprise any means for rotating the cradle 20 and secured container 80 known to one of skill in the art, including but not limited to a direct drive motor, a geared motor, a linear motor, a pneumatic drive, a belt drive, and the like.

The arc of rotation 38 of the cradle 20 and secured container 80 can comprise about 90 degrees, or until the access side 88 of the container 80 reaches a substantially horizontal position that is spaced above the horizontal receiving surface 70, as shown in FIG. 4. While not being bound to any particular theory, it is thought by the inventor that rotating the closed container 80 through a full 90 degree arc prior to depositing the poultry generally causes the birds within each level 91 to slide down the interior floors 90 onto the inside surfaces of the now-horizontal access doors 94, thereby extending the contact between the birds and the interior floors 90 in a manner that simultaneously reduces the speed and limits the sensation of free-fall that would otherwise be experienced by the birds, especially those birds located in the upper levels 91 of the container 80. This, in turn, can substantially reduce or eliminate any “fight or flight” responses in the poultry that could result in self-injurious or damaging activity throughout the combined rotation and unloading sequence. In this way the poultry can be moved to a position directly above the receiving surface 70 in a controlled manner that avoids triggering the birds' natural response to rapid displacement or acceleration.

In the embodiment of the unloading apparatus 10 illustrated in FIGS. 3-4, the arc of rotation 38 of the cradle 20 and secured container 80 can be a long-radius arc, in which the distance 33 between the engagement surfaces of the U-shaped base platform 22 (which supports the bottom 84 of the container 80) and the axis of rotation of the pivot mount 34, can be equal to at least 25% of the height of the transportation container 80 between the bottom panel 84 and the top panel 82. In other aspects this distance can be greater than 25% of the height of the container 80, up to and including 50% or 75% and above.

The long-radius arc may be advantageous for centering the transportation container 80 above the horizontal receiving surface 70 so that the poultry is deposited onto a center portion of the receiving surface. This feature can reduce the risk of the birds becoming temporarily densely packed against the side surfaces (not shown) of a framework that surrounds the horizontal receiving surface 70 during unloading. In addition, it is further contemplated that rotating the secured container 80 through a long-radius arc may also beneficially reduce the intensity of the rotational motion experienced by the poultry relative to the gravity component, thereby extending their sliding contact with the interior floors 90 of the container and further reducing their sensation of free-fall.

It will be understood, nevertheless, that the unloading apparatus of the present disclosure may also be adapted for use with poultry handling systems having a horizontal receiving surface or alternatively, a receiving opening, that is substantially narrower than the intake conveyor 72 shown in FIGS. 3-4. In this configuration the distance 33 between the axis of rotation defined by the pivot mounts 34 and the engagement surface of the base platform 22 can be much shorter than that shown in the drawings (i.e. less than 25% of the height of the transportation container 80 between the bottom panel 84 and the top panel 82), and the arc of rotation of the cradle and secured container may be considered a short-radius arc.

As illustrated in FIG. 4, in one aspect the spacing or distance 76A between the access side 88 of the container 80 and the horizontal receiving surface 70, upon completion of the rotation, can be less than the height 95 of the doors 94, down to and including a spacing of about one inch between the two surfaces. In this case, when the doors 94 are released or allowed to open via a door opening mechanism, as described in more detail below, the outer edges 98 of the doors 94 can drop down to contact the horizontal receiving surface 70 that prevents the doors from opening further. This allows the poultry to gently slide or roll out of the container 80 along the smooth ramp surfaces provided by the doors 94 until they are deposited onto the receiving surface 70. In one aspect the power mechanism 50 can be activated to retract or lift the cradle 20 and container 80 simultaneous with the opening of the doors 94, or shortly thereafter, so as to steadily increase the spacing 76A between the access side 88 and the receiving surface 70. This in turn allows the doors 94 to open completely and for all the poultry 80 within the container to be completely unloaded or deposited onto the receiving surface 70 in a substantially vertical fashion, and with a minimal amount of free fall. In this configuration it may be advantageous for the belt of the intake conveyor 72 to be momentarily stopped, as indicated above, thereby avoiding the creation of a pinch-point between the moving belt and the framework of the transportation container, as well avoiding any damage or tearing of the belt by the free edges 98 of the doors 94 resting against the receiving surface 70.

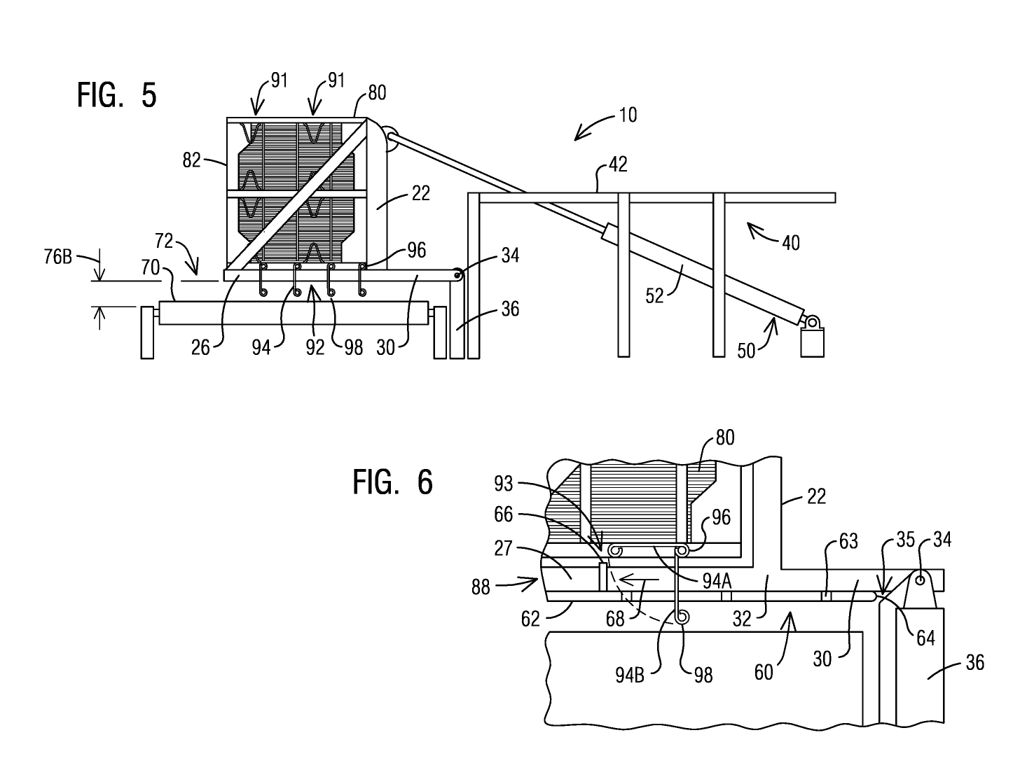

Alternatively, as shown in FIG. 5, the spacing or distance 76B between the access side 88 of the container 80 and the horizontal receiving surface 70, upon completion of the rotation, can be equal to or greater than the height 95 of the doors 94. Thus, when the doors 94 are released or allowed to open via the door opening mechanism, the doors 94 can swing directly down around their door pivots 96 to a vertical and completely-open orientation, with the rounded outer edges 98 of the doors 94 remaining at or above the horizontal receiving surface 70. This configuration can be advantageous for avoiding contact between the receiving surface 70 and the doors 94 that may result in wear and tear on the belt of the intake conveyor 72, while only allowing the poultry to drop a minimum height, specifically the height 95 of the doors 94, from each access opening 92 during deposition of the live birds onto the receiving surface.

One embodiment of a door-opening mechanism 60 is illustrated in FIG. 6, in which at least one of the side bars 27 of the side support and one of the support pillars 30 are formed or combined together into an elongate column 32, and a bar 62 is slidably secured with guide tubes 63 proximate to the outer surface of the column 32. The lower end of the bar 62 can comprise a contact surface 64 that rides against a stationary cam surface 35 located adjacent to the pivot mount 34. The bar 62 can further include a plurality of latch members 66 that press against the outer edges 98 of the doors to maintain each of the doors in its closed position (94A), even after the transportation container 80 has been rotated in the cradle and the poultry contained within the container has slid down to rest against the inside surface of the doors. As the cradle reaches the unload position with the access side 88 in a substantially horizontal position, the cam 35 can be configured to press against the contact surface 64 to move the bar 62 outward so that the latch members slide out from under the outer edges 98 of the doors and into the gaps 93 between the doors and the next upper level 91, allowing the doors to swing downward, under the weight of the poultry, to their open positions (94B), as described above.

In a preferred embodiment the door opening mechanism is generally activated simultaneous with the access side reaching the substantially horizontal orientation, in which case the cam-activated door opening mechanism of FIG. 6 described above could provide a suitable functionality. Alternatively, in other embodiments it may be desirable to either slightly advance or momentarily delay the activation of the door opening mechanism 60 relative to the access side reaching the substantially horizontal orientation, so as to better smooth or control the unloading process. In this case an electronic timer or controller in combination with movable actuator could be used to provide the desired adjustment in the unloading sequence.

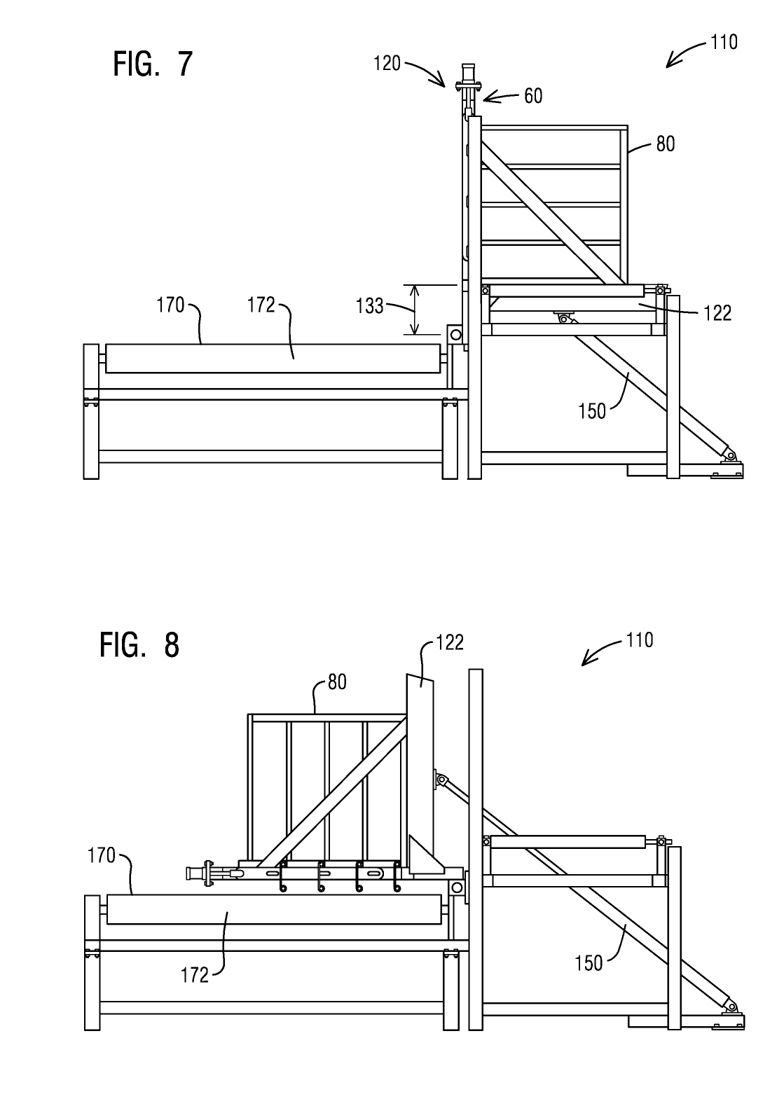

Another embodiment of the unloading apparatus 110 is shown in FIGS. 7-10, with FIGS. 7-8 depicting the transportation container 80 filled with live poultry secured within the cradle 120 in an upright position (FIG. 7) and in an unload position (FIG. 8). In this embodiment the distance 133 between the pivot mounts 134 and the engagement surfaces of the base platform 122 can be reduced so as to create a shorter arc of rotation, which in turn allows the power mechanism 150 to be moved closer to the pivot mounts 134 with a corresponding reduction in the overall footprint of the unloading apparatus 110. The reduction in the radius of rotation of the base platform 22 can also shift the transportation container 80 away from a centered position above the horizontal receiving surface 170 of the intake conveyor 172 after rotation in the unload position. Nonetheless, the reduced distance 133 can be still sufficient to provide for a long-radius arc that beneficially extends the sliding contact of the poultry with the interior floors 90 of the container and reduces the sensation of free-fall experienced by the poultry over other unloading systems known in the art. For example, the distance 133 between the pivot mounts 134 and the engagement surfaces of the base platform 122 of the cradle 120 shown in FIGS. 7-10 can be about 17 inches, or about 35% of the height 83 of the transportation container 80, which will generally be about 48 inches.

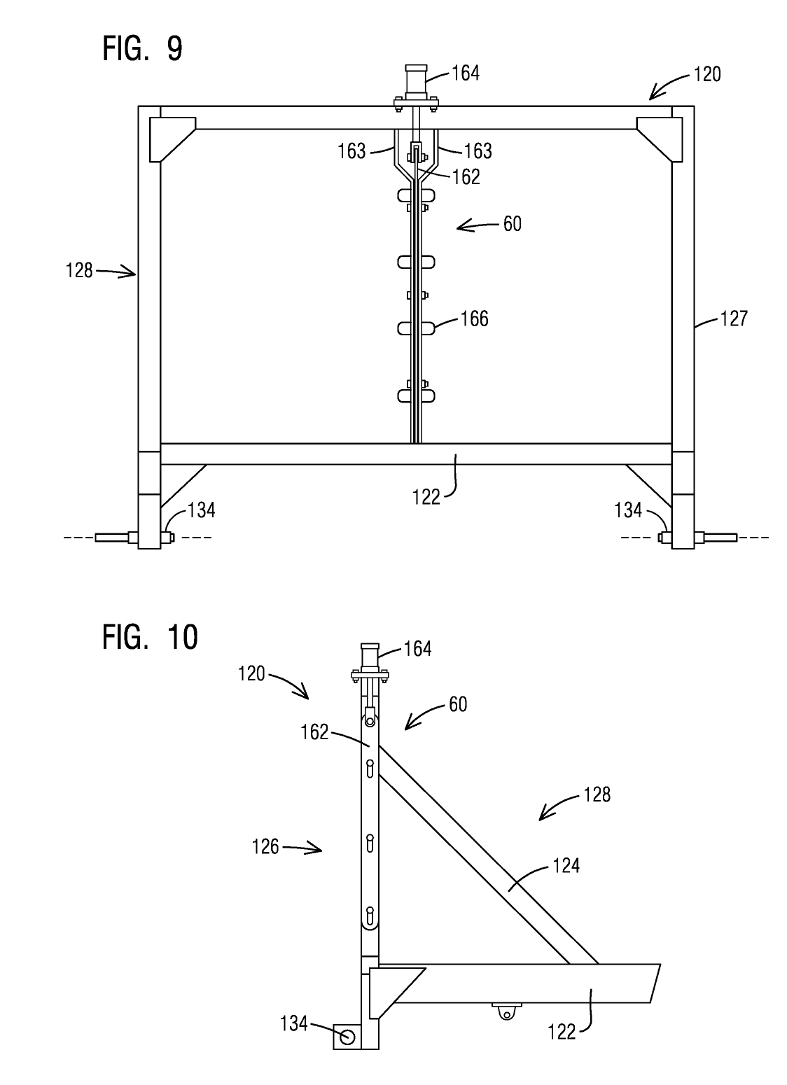

As shown in FIGS. 9-10, the cradle 120 of the unloading apparatus 110 can also include an electronically activated door-opening mechanism 160 that is positioned between the pair of elongate side bars/support pillars 127 that define the sides of the cradle. The door-opening mechanism can include an actuator 164 that is electronically activated upon rotation of the cradle 120 to the unload position (FIG. 8). The actuator 164 can be motorized, pneumatic-powered, hydraulic-powered, electro-magnetically powered, and the like.

As shown in the drawings, in one aspect the door-opening mechanism 160 can comprise a movable bar 162 that is slidably supported between two fixed bars 163 mounted to the side frame or support 126 in a centered location between the elongate side bars/support pillars 127. Similar to the door-opening mechanism of the previous embodiment, the slide bar 62 can include a plurality of latch or flange members 166 that press against the outer edges of the doors 94 to maintain each of the doors in its closed position, even after the transportation container 80 has been rotated in the cradle 120 and the poultry contained within the container has slid down to rest against the inside surface of the doors 94. As the cradle reaches the unload position with the access side 188 in a substantially horizontal position, the actuator 164 can be actuated to pull the slide bar 162 away from the base of the transportation container 80 so that the flange members 166 slide out from under the outer/upper edges of the doors and into the gaps between the upper edges of the doors and the next upper level, thereby allowing the doors to swing downward, under the weight of the poultry, to their open positions.

Furthermore, it is understood that other devices and methods, whether mechanical, pneumatic, hydraulic, electrical or magnetic in nature, or combinations thereof, for maintaining the doors 94 of the transportation container 80 in a closed position throughout the rotation of the container, and then opening the doors or allowing the doors to open once the cradle and container have reached the unload position, are also possible and considered to fall within the scope of the present disclosure.

The invention has been described herein in terms of preferred embodiments and methodologies considered by the inventor to represent the best mode of carrying out the invention. It will be understood by the skilled artisan, however, that a wide range of additions, deletions, and modifications, both subtle and gross, may be made to the illustrated and exemplary embodiments of the composite substrate without departing from the spirit and scope of the invention. For example, adjustable pivot mounts and/or support pillars that would enable a user to change the elevation of the access side of the transportation containers in the unload position, so as to account for variations in the height of the doors and minimize the gap between the receiving surface and the access openings, are also possible and considered to fall within the present disclosure. These and other revisions might be made by those of skill in the art without departing from the spirit and scope of the invention that is constrained only by the following claims.

What is claimed is:

1. A method for unloading live poultry onto a horizontal receiving surface from a multi-level transportation container having an access side with an opening at each level and a door for closing each opening, the method comprising:
receiving the transportation container within a support cradle that is rotatably supported on at least one pivot mount, with the access side of the transportation container being in a substantially vertical orientation;
rotating the support cradle and the transportation container together through an angle of about 90 degrees until the access side of the transportation container is in a substantially horizontal orientation above the horizontal receiving surface;
maintaining the doors of the transportation container in a closed position during rotation of the support cradle and transportation container; and
upon reaching the substantially horizontal orientation, activating a door opening mechanism to open the doors and deposit live poultry contained therein onto the horizontal receiving surface.

2. The method of claim 1, further comprising rotating the support cradle and the transportation container upward and backward until the access side of the transportation container is returned to the substantially vertical orientation.

3. The method of claim 2, further comprising rotating the support cradle and the transportation container upward and backward substantially upon activation of the door opening mechanism to assist with the deposition of the live poultry onto the horizontal receiving surface.

4. The method of claim 2, further comprising waiting to rotate the support cradle and the transportation container upward and backward until after deposition of the live poultry onto the horizontal receiving surface is complete.

5. The method of claim 1, further comprising activating the door opening mechanism simultaneously with the access side reaching the substantially horizontal orientation.

6. The method of claim 1, further comprising waiting for a predetermined period of time after the access side reaches the substantially horizontal orientation before activating the door opening mechanism.

7. An apparatus for unloading live poultry onto a horizontal receiving surface from a multi-level transportation container having an access side with an opening at each level and a door for closing each opening, the apparatus comprising:
a cradle including:
a base platform configured to receive and support a bottom of the transportation container;
a side support extending upward from a side of the base platform and configured to receive and support the access side of the transportation container; and
at least one support pillar extending downward to engage with at least one pivot mount that is spaced from and below the base platform;
a power mechanism configured to rotate the cradle with a transportation container received therein from an upright position, with an access side of the transportation container being in a substantially vertical orientation, around the at least one pivot mount to an unload position, with the access side being in a substantially horizontal orientation above and spaced from the horizontal receiving surface; and
a door-opening mechanism configured maintain the doors for each level in a closed position until the transportation container reaches the unload position, and then to open the doors to deposit live poultry contained therein onto the horizontal receiving surface.

8. The apparatus of claim 7, wherein the access side of the transportation container in the unload position is spaced from the horizontal receiving surface by a distance that is greater than or about a height of the doors.

9. The apparatus of claim 7, wherein the access side of the transportation container in the unload position is spaced from the horizontal receiving surface by a distance that is less than a height of the doors.

10. The apparatus of claim 7, wherein the horizontal receiving surface is a translatable belt of a conveyor.

11. The apparatus of claim 7, wherein the at least one support pillar extends downward below the side support.

12. The apparatus of claim 7, wherein the cradle support further comprises a pair of support pillars extending downward at either end of the base platform to engage with a pair of pivot hinges.

13. The apparatus of claim 12, wherein the side support further comprises a side frame with end pillars that extend downward at either end to form the pair of support pillars.

14. The apparatus of claim 12, wherein the door opening mechanism is positioned between the pair of support pillars.

15. The apparatus of claim 14, wherein the door opening mechanism further comprises a slide bar having flange plates extending laterally to maintain the doors in the closed position during rotation of the transportation container.

16. The apparatus of claim 15, wherein the flange plates are movable to align with gaps between the upper edges of the doors and the next upper levels of the transportation container to release the doors for opening under the weight of the live poultry.

17. The apparatus of claim 7, wherein the power mechanism is a double-acting hydraulic cylinder connected to an underside of the base platform.

18. The apparatus of claim 7, wherein an elevation of the at least one pivot mount is spaced less than or about 8 inches above an elevation of the horizontal receiving surface.

19. The apparatus of claim 7, wherein the at least one pivot mount is spaced below a bottom of the transportation container received within the cradle by a distance that is greater than or about 25% of an overall height of the transportation container.

20. The apparatus of claim 7, wherein the at least one pivot mount is spaced below a bottom of the transportation container received within the cradle by a distance that is less than 25% of an overall height of the transportation container.
